(19) United States
(12) Patent Application Publication
(10) Pub. No.: US 2025/0251256 A1
(43) Pub. Date: Aug. 7, 2025

(54) SYSTEMS AND METHODS FOR SCALABLE GEOSPATIAL DATA COLLECTION

(71) Applicants: Sravan Puttagunta, Woodland, CA (US); Augmented Reality Media Corp., Woodland, CA (US)

(72) Inventor: Sravan Puttagunta, Sacramento, CA (US)

(21) Appl. No.: 18/614,463

(22) Filed: Mar. 22, 2024

Related U.S. Application Data
(60) Provisional application No. 63/454,546, filed on Mar. 24, 2023.
(60) Provisional application No. 63/454,539, filed on Mar. 24, 2023.
(60) Provisional application No. 63/454,528, filed on Mar. 24, 2023.

(51) Int. Cl. G01C 21/00; G01S 17/89; G06V 10/26; G06V 10/82; G06V 20/10; G06V 20/17

(52) U.S. Cl. CPC G01C 21/3833; G01S 17/89; G06V 10/26; G06V 10/82; G06V 20/17; G06V 20/194

(57) ABSTRACT

This patent discloses innovative technologies for efficient and scalable collection, processing, and analysis of geospatial data. The proposed solutions encompass advanced hardware components, such as sensors, cameras, vehicles, satellites, LiDAR systems, and GPS devices, enabling high-precision data acquisition. The invention also introduces sophisticated software algorithms and techniques for processing and analyzing large volumes of geospatial data, including data fusion, feature extraction, image processing, and machine learning approaches. Additionally, the patent addresses the challenges of scalability and efficiency by optimizing data acquisition workflows, reducing processing time and resource requirements, and improving the accuracy and reliability of collected data. The disclosed technologies are designed to support a wide range of applications and use cases, such as mapping, surveying, navigation, urban planning, environmental monitoring, agriculture, disaster response, and infrastructure management. Furthermore, the patent explores methods for seamless integration with existing infrastructure, software platforms, and data management systems, enabling interoperability and data sharing. Overall, this invention offers innovative solutions for efficient and scalable geospatial data collection, processing, and analysis, with potential applications across various domains.

### CROSS-REFERENCE OF RELATED APPLICATIONS

This application claims priority under 35 USD § 119 (e) to U.S. Provisional Application Nos. 63/454,528, filed Mar. 24, 2023, 63/454,539, filed on Mar. 24, 2023, and 63/454,546, filed Mar. 24, 2023, the contents of which is hereby incorporated by reference in its entirety.

### BACKGROUND OF THE INVENTION

### 1. Field of the Invention

The field of the invention for “Systems and Methods for Scalable Geospatial Data Collection” pertains to technology related to the acquisition, processing, and utilization of geospatial data in a scalable manner using vehicle fleets that operate within transportation network companies.

### 2. Description of the Related Art

Mapping fleets are currently limited in size. For example, the largest mapping fleet in the world is a few hundred vehicles with map data being refreshed every 3 years. This is the case because operating a mapping fleet is expensive and cost prohibitive. This is mainly due to the fact that traditionally a mapping fleet requires revenue from map licensing in order to operate a vehicle fleet.

### BRIEF SUMMARY OF THE INVENTION

The present invention comprises a novel process, systems and methods which enable scalable geospatial mobile mapping at a worldwide stage without the need to finance the mapping operations.

The invention broadly describes a system and its subsystems which in combination with a novel process may lead to planetary scale geospatial data collection solution which is resilient, scalable and current; enabling actionable geospatial intelligence to maintain and reverse the effects of aging infrastructure.

The invention described in detail is not limited in its applications to the details of the construction and to the arrangements of the components set forth in the following description or illustrated in the drawings. The invention is capable of other embodiments and of being practiced and carried out in different ways. Also, it is to be understood that the phraseology and terminology employed herein are for the purpose of the description and should not be regarded as limiting.

One object of the present invention is to collect geospatial data from 3D mapping kits mounted on a dual purpose vehicle which serves two purposes. Utilization of a dual purpose vehicle is to collect 3D geospatial data obtained from a multimodal sensor suite while simultaneously utilizing TNC networks to route and dispatch the dual purpose vehicle based on notifications or requests on the TNC network.

Second object of the present invention is to enable a ubiquitous localization solution to act as a common reference coordinate frame to fuse multimodal sensor data from multiple arrivals to a particular scene either temporally from the same dual purpose vehicle or from other dual purpose vehicles or from other geospatial datasets.

Third object of the present invention is the conversion of the geospatial data into a world model based on a real time mapping engine which is capable of vectorization, relational connectivity, spatial understanding, spatial reasoning, and semantic contextualization for arbitrary queries. Fourth object of the present invention is the generative creation of 360 RGB images from the point cloud data obtained from the LiDAR sensor in the multimodal sensor suite. This is useful to go between the reflectivity and the RGB domain signals seamlessly.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

### Description of Figures

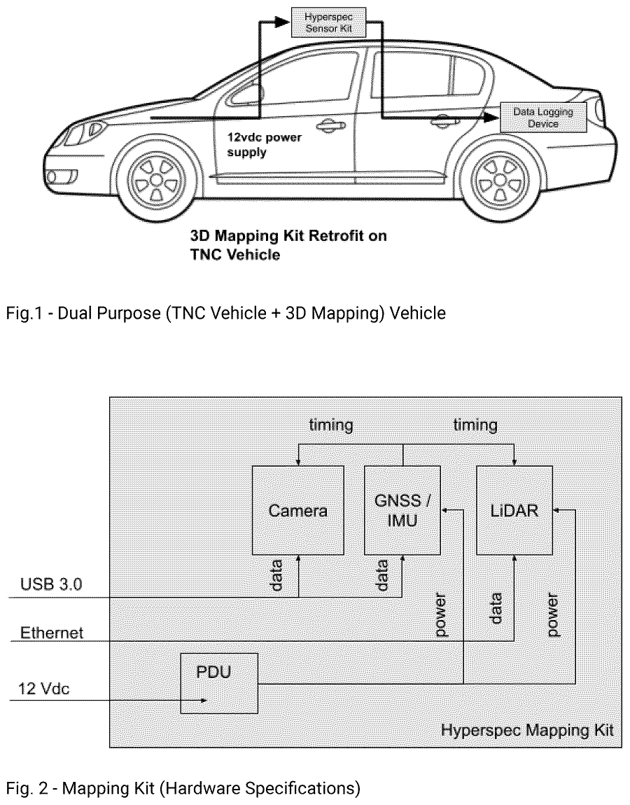

FIG. 1—Dual Purpose (TNC Vehicle+3D Mapping) Vehicle

FIG. 2—Mapping Kit (Hardware Specifications)

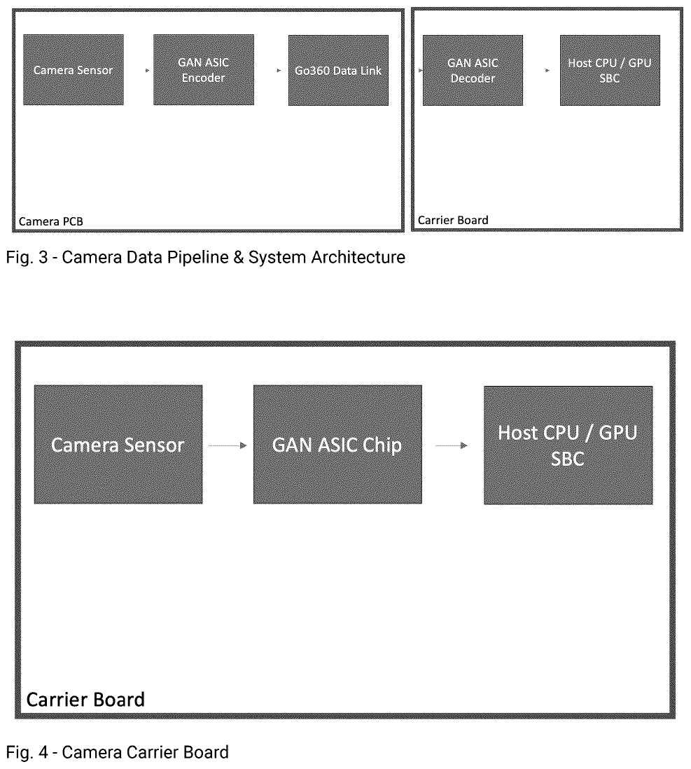

FIG. 3—Camera Data Pipeline & System Architecture

FIG. 4—Camera Carrier Board

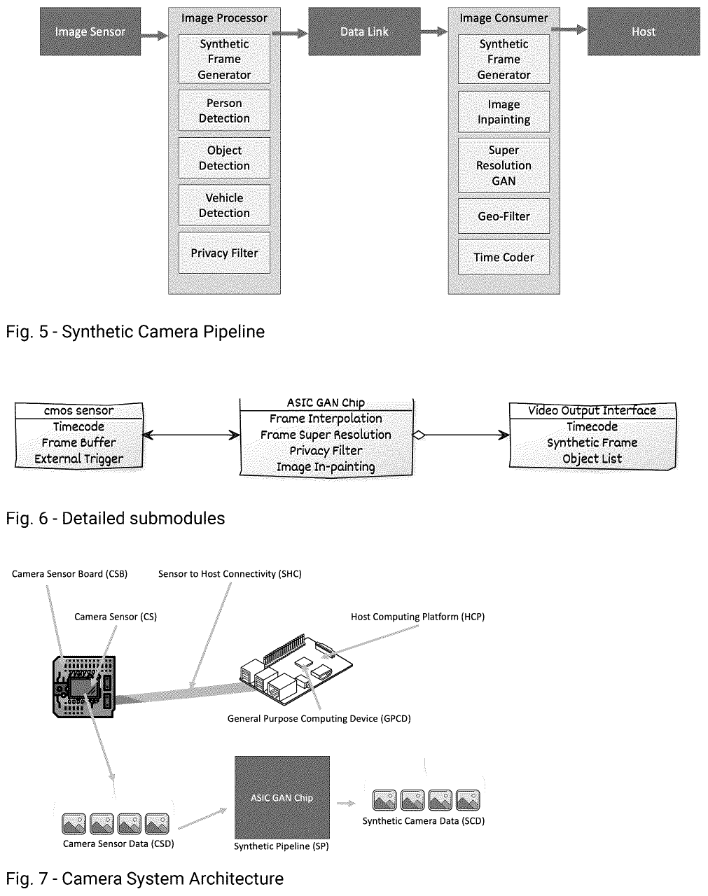

FIG. 5—Synthetic Camera Pipeline

FIG. 6—Detailed submodules

FIG. 7—Camera System Architecture

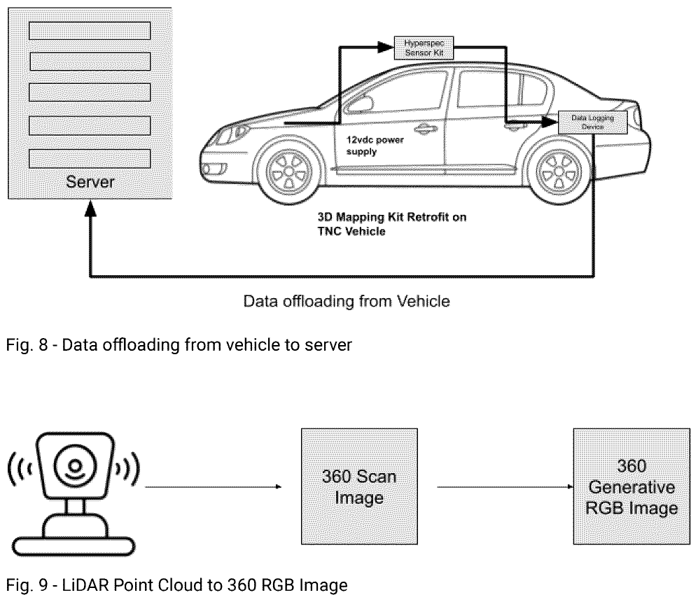

FIG. 8—Data offloading from vehicle to server

FIG. 9—LiDAR Point Cloud to 360 RGB Image

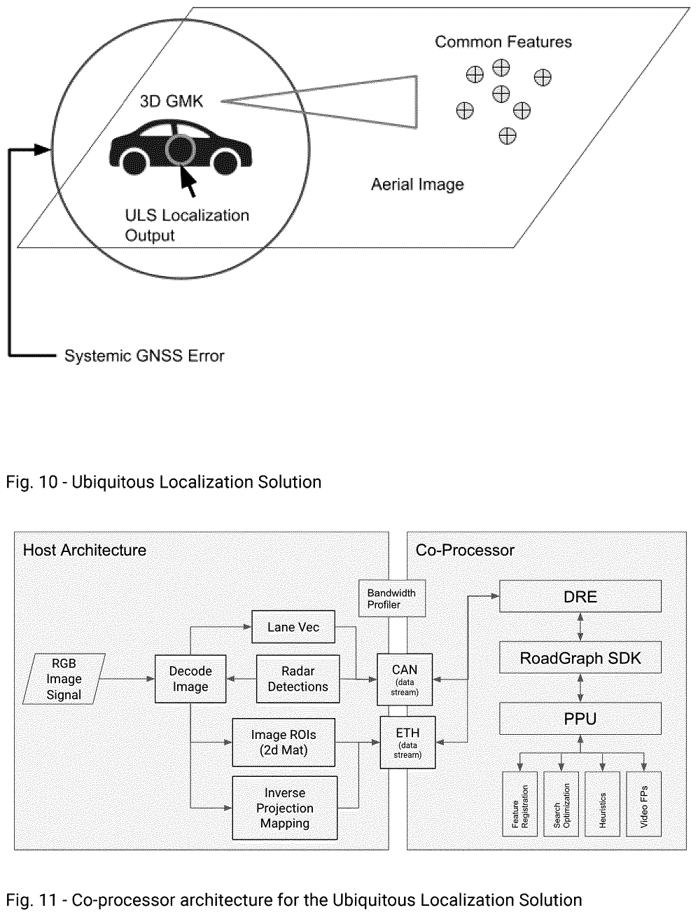

FIG. 10—Vision-based Ubiquitous Localization Solution (ULS)

FIG. 11—Co-Processor Architecture for the ULS

Various other objects, features and attendant advantages of the present invention will become fully appreciated as the same becomes better understood when considered in conjunction with the accompanying drawings, in which like the figures describe aspects of the invention through several views, and wherein:

FIG. 1 is an illustration of the transportation network company (TNC) vehicle retrofitted with a 3D geospatial mapping kit. The figure details the power source, the mapping kit itself and the data collection system. The figure represents one such example of layout of the subcomponents described in the invention and other variations of the subcomponents being laid out differently may exist

FIG. 2 is an illustration of the multimodal sensors and the wiring schematic of the submodules with a brief visualization of the types of data being transmitted between subcomponents of the 3D geospatial mapping kit.

FIG. 3 is an illustration of the camera data pipeline encompassing a sequence of streams transmitting data across two subsystems.

FIG. 4 is an illustration of the camera data pipeline architecture transmitting data from the sensor to the application space

FIG. 5 is an illustration detailing one example of the separation of sub-tasks at various stages of the camera pipeline

FIG. 6 is a more detailed illustration of the submodules and the subroutines which are encompassed by the submodules.

FIG. 7 is an illustration of the system level architecture showcasing the raw imagery and the generative camera frames alongside the camera components.

FIG. 8 is an illustration of how the vehicle may offland data from its onboard storage infrastructure to an external storage infrastructure.

FIG. 9 is an illustration of raw point cloud data being transmuted into a generative RGB image.

FIG. 10 is an illustration of the Ubiquitous Localization Solution. It clearly shows how the vehicle refines its position accuracy by utilizing common features visible both in the Aerial Imagery datasets and the geospatial data being collected on board.

FIG. 11 is an illustration of a co-processor architecture where the processing pipeline is split between the Host PC and a co-processor.

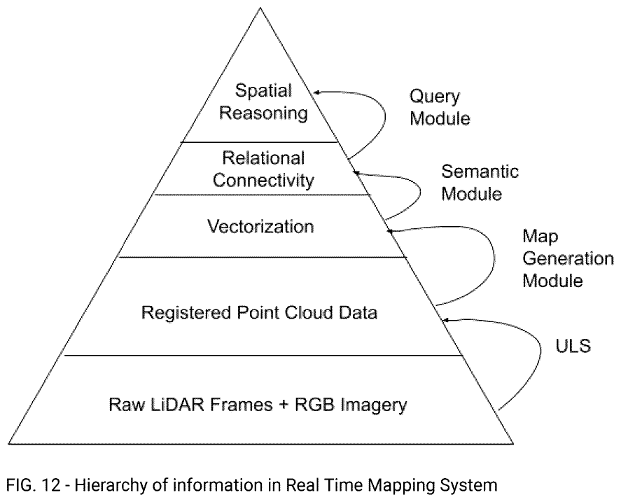

FIG. 12 is an illustration of the hierarchy of information depicting how information is transformed from the raw 3D geospatial data into higher level contextual information with each additional layer of complexity.

### DETAILED DESCRIPTION OF THE INVENTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. The present invention may be operated as a computer program installed upon a download computer, via a website or other system. It can be also appreciated that even though the description below is about downloading, searching and managing electronic patent files, the present invention may also be utilized for downloading, searching and managing electronic trademark files.

The illustration in FIG. 1 describes the system utilized by the dual purpose vehicle (DPV) to operate in a transportation network company (TNC) marketplace, the 3D geospatial mapping kit (3D GMK) and the data logging device. The DPV may utilize a smartphone or general purpose computing device to communicate with a TNC notification system to receive various requests for tasks. The smartphone or general purpose computing device may render the information from the TNC notification system and may expose tactile interfaces for accepting, declining the requests for tasks.

The illustration in FIG. 1 describes the system utilized by the DPV, the 3D GMK and the data logging device (DLD). The DPV may utilize a smartphone or general purpose computing device to communicate with a TNC notification system to receive various requests for tasks. The smartphone or general purpose computing device may render the information from the TNC notification system and may expose tactile interfaces for completing pending tasks in a queue.

The illustration in FIG. 1 describes the system utilized by the DPV, the 3D GMK and the DLD. The DPV may utilize a smartphone or general purpose computing device to communicate with a TNC notification system to receive various requests for tasks. The smartphone or general purpose computing device may render the information from the TNC notification system and may deposit money into a digital wallet for completion of various tasks obtained from a TNC notification system.

Simultaneously, the 3D GMK as illustrated in FIG. 1 may obtain geospatial data from the various sensors. The 3D GMK may utilize multiple modalities of sensor data where one such example is shown in FIG. 2 to log data into a data logging device (DLD) using time synchronization signals to align the sensor frames.

The DPV may log 3D geospatial mapping data to its DLD while simultaneously receiving requests from the TNC notification system and complete tasks from the TNC task queue for various types of tasks. The TNC task queue may include tasks that focus on transportation of people, delivery of goods and mobile retail storefronts. The TNC task queue may include tasks that may include any arbitrary reason for a vehicle movement through various locations on a road network in exchange for monetary compensation.

The TNC wallet may accumulate payment deposits from the completion of a series of TNC tasks requests whilst simultaneously allowing the DPV to log 3D geospatial mapping data to the DLD. The TNC wallet may distribute payments from its balance to a fleet operator account or to individuals based on a user interface which tracks vehicle movements of a TNC fleet.

In FIG. 2 the modal components of the 3D GMK are interconnected via a ware harness which transmits data over 12 Vdc power and via USB/Ethernet. The timing signals for the sensors use pulse code modulation to synchronize the sensor clock with the various modal sensors in the 3D GMK.

As various DPV vehicles cross paths on a road network, their 3D geospatial data will intersect and exhibit various inconsistencies due to GNSS error. A ubiquitous coordinate system which enables the data to be self consistent locally and globally becomes necessary. A ubiquitous coordinate frame is important to enable the 3D geospatial data to be self consistent.

The ubiquitous localization solution (ULS) utilizes Aerial Imagery datasets as a reference for localization. These datasets consist of high-resolution images captured at a Ground Sample Distance (GSD) of 7-15 cm or 15-30 cm. This GSD provides enough detail for the system to accurately determine the position of a vehicle or device.

The ULS utilizes a rough GPS location to initiate the triangulation process. This rough GPS location is then refined by the vision position system, which compares the image-based features of the current location with those present in the aerial imagery datasets. This enables the system to determine the precise position of the vehicle or device with submeter precision.

Unlike traditional localization solutions based on GPS/GNSS or HD Maps/Feature Maps, the ULS is not limited by coverage and provides a more reliable way of determining the location. GPS/GNSS signals are prone to noise and can be disrupted by physical obstructions, leading to inaccurate positioning. HD Maps/Feature Maps have incomplete coverage and can be vulnerable to spoofing.

The ULS overcomes these limitations by cross-matching image-based features with sensor data. This allows the ULS to accurately determine the position of the vehicle or device even in areas where traditional localization solutions may fail. The ULS provides a reliable and precise method of determining the location of a vehicle or device, making it suitable for a wide range of applications in the field of mapping, autonomous vehicles, drones, and IoT devices.

The ULS for localization utilizing Aerial Imagery datasets consists of the following subcomponents and their interactions: Aerial Imagery Datasets: These are high-resolution images captured at a Ground Sample Distance (GSD) of 7-15 cm or 15-30 cm. They provide the reference for the ULS to determine the position of a vehicle or device. GPS/GNSS: ULS utilizes a rough GPS location to initiate the triangulation process. This rough GPS location is then refined by the vision position system to determine a more precise position. Vision Position System (VPS): ULS compares the image-based features of the current location with those present in the aerial imagery datasets to determine the precise position of the vehicle or device. The VPS relies on image recognition algorithms and computer vision techniques to accurately match the features. 3D Geospatial Data (3D GD): The ULS cross-matches image-based features with 3D GD to provide a more reliable way of determining the location. The 3D GD data includes information such as accelerometer readings, gyroscope readings, and other sensory inputs that can provide additional information to refine the position. Localization Output: The output of the ULS is the precise location of the vehicle or device. This information can be used by autonomous vehicles, drones, and IoT devices to navigate and interact with their surroundings. The subcomponents of the ULS interact with each other to provide a reliable and precise method of determining the location. The GPS/GNSS provides a rough location, which is then refined by the vision position system using aerial imagery datasets and sensor data. This interaction between the subcomponents ensures that the output of the system is accurate and reliable, making it suitable for a wide range of applications in the field of 3D mapping, autonomous vehicles, drones, and IoT devices. FIG. 10 represents a visualization of the ULS system and its submodules.

The VPS is a crucial component of the ULS utilizing Aerial Imagery datasets. The ULS uses computer vision techniques and image recognition algorithms to compare the image-based features of the current location with those present in the aerial imagery datasets. This comparison allows the system to determine the precise position of the vehicle or device. The vision positioning system has many subcomponents.

Image Recognition Algorithms: These algorithms are used to match the image-based features of the current location with those present in the aerial imagery datasets. The algorithms process the images and extract relevant features such as lines, shapes, and textures. These features are then compared to those present in the aerial imagery datasets to determine the precise position.

Feature Extraction: This subcomponent extracts relevant features from the images captured by the VPS. The features are used to match the current location of the DPV with those present in the aerial imagery datasets. The features can include lines, shapes, textures, and other relevant information that can be used to determine the position.

Image Processing: The images captured by the VPS are processed to extract relevant information that can be used to determine the position. This process includes resizing, filtering, and transforming the images to make them suitable for image recognition algorithms.

Pose Estimation: This subcomponent estimates the pose, or position and orientation, of the DPV or device based on the image-based features. The pose estimation process relies on computer vision techniques and algorithms to determine the position and orientation of the device.

The VPS subcomponents work together to determine the precise position of the DPV or other device. The image recognition algorithms match the image-based features of the current location with those present in the aerial imagery datasets, while the feature extraction and image processing subcomponents ensure that the images are suitable for matching. The pose estimation subcomponent provides the final output of the ULS, which is the precise location of the DPV or other devices.

The utilization of Hyperspectral Imagery can greatly enhance the image segmentation and classification of objects from the aerial perspective in the proposed ULS by utilizing Aerial Imagery datasets. Hyperspectral imagery captures images across a large number of spectral bands, providing more information about the objects being imaged. This information can be leveraged to better classify and segment objects in the aerial images, making the localization process more accurate.

Unsupervised image segmentation on the ground involves clustering similar pixels into groups based on their spectral properties. These clusters can be used to match against the clusters from the hyperspectral images, providing a more robust and accurate method of object classification and segmentation. This process can also be used to classify objects based on their spectral properties, allowing the system to differentiate between different types of objects, such as vegetation, roads, and buildings.

The unsupervised image segmentation process can be leveraged by comparing the clusters on the ground with those from the hyperspectral images. The ULS can use this information to determine the type of objects present in the aerial images, and use this information to better classify and segment the objects. This helps to improve the accuracy of the localization process, as the ULS can now differentiate between different types of objects and make more informed decisions about the location of the DPV or device.

By combining the information from the hyperspectral imagery with the rough GPS location and the image-based features from the VPS, the proposed ULS can provide more precise and reliable localization. The use of hyperspectral imagery enables the system to better classify and segment objects, allowing it to make more informed decisions about the location of the vehicle or device. This enhances the overall performance of the system, providing submeter precision in localization as opposed to typical localization solutions based on GPS/GNSS or HD Maps/Feature Maps.

The utilization of hyperspectral imagery in combination with unsupervised image segmentation on the ground and the VPS, provides a more robust and reliable method for object classification and localization. The system leverages the spectral information from the hyperspectral imagery, the image-based features from the vision positioning system, and the rough GPS location to provide submeter precision in localization.

ULS utilizes Aerial Imagery datasets and can also leverage Lidar SLAM (Simultaneous Localization and Mapping) using Lidar Odometry to register a point cloud. The registered point cloud can be used to create a bird's eye view image of the environment, which can be used to match with aerial imagery to localize the vehicle.

Lidar SLAM uses Lidar Odometry to estimate the motion of the vehicle based on the lidar readings. This provides a high-resolution 3D point cloud of the environment, which can be used to create a bird's eye view image. The bird's eye view image is a 2D representation of the environment created by projecting the 3D point cloud onto a 2D plane.

The bird's eye view image can be used to match with the aerial imagery, allowing the system to localize the vehicle. This process involves comparing the features of the bird's eye view image with those present in the aerial imagery datasets. The ULS uses computer vision techniques and image recognition algorithms to determine the precise location of the DPV based on the matched features.

The following are the subcomponents of the process and how they interact:

Lidar Odometry: This subcomponent estimates the motion of the DPV based on the lidar readings. It uses algorithms to calculate the relative position and orientation of the DPV based on the lidar readings, providing a high-resolution 3D point cloud of the environment.

Point Cloud Registration: This subcomponent registers the point cloud to a common reference frame, allowing the system to create a bird's eye view image of the environment. The registration process involves aligning the point cloud with a reference frame, such as a map or a previously captured point cloud.

Bird's Eye View Image Generation: This subcomponent creates a 2D representation of the environment based on the registered point cloud. The bird's eye view image is created by projecting the 3D point cloud onto a 2D plane.

Image Recognition Algorithms: The image recognition algorithms are used to match the features of the bird's eye view image with those present in the aerial imagery datasets. The algorithms process the images and extract relevant features such as lines, shapes, and textures. These features are then compared to those present in the aerial imagery datasets to determine the precise location of the DPV.

Feature Extraction: This process involves extracting relevant features from the bird's eye view image. The features are used to match the current location with those present in the aerial imagery datasets. The features can include lines, shapes, textures, and other relevant information that can be used to determine the location as visualized in FIG. 10.

The subcomponents of ULS work together to provide a more precise and reliable method of localization. Lidar Odometry provides the 3D point cloud of the environment, which is registered and used to create a bird's eye view image. The image recognition algorithms then match the features of the bird's eye view image with those present in the aerial imagery datasets to determine the precise location of the vehicle.

The process of localization utilizing Aerial Imagery datasets can leverage Lidar SLAM and Lidar Odometry to register a point cloud and create a bird's eye view image of the environment. The bird's eye view image is then matched with the aerial imagery datasets to localize the DPV. The process involves the subcomponents of Lidar Odometry, Point Cloud Registration, Bird's Eye View Image Generation, Image Recognition Algorithms, and Feature Extraction, which work together to provide a more precise and reliable method of localization.

The proposed ULS utilizing Aerial Imagery datasets can be further extended to include new derivative ideas to improve the accuracy and reliability of the localization process.

Multi-Modal Fusion: The proposed ULS can be extended to include multi-modal fusion, where multiple sensors are used to provide more accurate and reliable localization. This can include Lidar, Radar, Visual Odometry, and other sensors. The data from these sensors can be fused to provide a more comprehensive view of the environment, improving the accuracy and reliability of the localization process.

Deep Learning-based Image Segmentation: The proposed ULS can be extended to include deep learning-based image segmentation to improve the accuracy of image recognition algorithms. Deep learning algorithms can be trained on large datasets to identify and segment objects from aerial imagery. This can be used to improve the accuracy of the localization process by providing a more precise representation of the environment.

Enhanced GPS/GNSS: The proposed ULS can be extended to include enhanced GPS/GNSS, which can be used to provide a more accurate initial position estimate. Enhanced GPS/GNSS can use multiple satellite signals and advanced algorithms to improve the accuracy of the GPS signal. This can be used to provide a more accurate starting point for the localization process, reducing the amount of error introduced by the system.

Real-Time Map Updating: The proposed ULS can be extended to include real-time map updating, which can be used to improve the accuracy and reliability of the localization process over time. The system can continuously update the aerial imagery datasets based on new data captured by the sensors, providing a more up-to-date and accurate representation of the environment.

The proposed ULS may utilize a co-processor that takes the feature descriptors as inputs instead of raw sensor data or aerial imagery datasets. The preprocessing step for the raw sensor data and aerial imagery datasets is essential to convert the data into a format that can be easily processed by the co-processor. The preprocessing step includes extracting features from the data and converting the features into a compact and lightweight format.

The co-processor can then take the feature descriptors as inputs and match them with the aerial imagery datasets to provide a more precise localization solution. The co-processor can be designed as a lightweight architecture that leverages the output of the larger upstream processor to utilize the feature descriptor data. This would enable existing systems to add the more precise localization capability without requiring a new dedicated processor architecture.

The co-processor could be a microcontroller while the upstream larger processor could be a system on chip with larger computing capabilities. This architecture allows for the division of labor between the two processors, with the larger processor handling heavy computation tasks and the smaller processor focusing on low-latency tasks such as real-time feature extraction and processing.

The sensor data is transformed into feature descriptor data by the larger processor, which is then sent to the co-processor over low bandwidth protocols such as CANBus. The feature descriptors are compact representations of the data that allow for efficient transmission and processing.

There are many potential variations of this architecture, each with different trade-offs between upstream processing resources and downstream processing capability. Some possible variations include: A large upstream processor with extensive computing resources and a small, low-power co-processor for real-time feature extraction and processing. A hybrid architecture with a large upstream processor and multiple smaller co-processors for parallel processing. A multi-tier architecture with multiple levels of processing, each with decreasing amounts of compute resources, to handle increasingly abstract reasoning. An architecture that uses lightweight feature descriptors to process data in real-time on embedded systems with limited computing resources. An architecture that integrates multiple systems, such as autonomous vehicles and smart cities, to provide a unified view of the environment. An architecture that uses edge computing to process data locally, reducing the amount of data that needs to be transmitted to a centralized server. An architecture that uses the Internet of Things (IoT) to transmit feature descriptor data over low-bandwidth protocols such as LoRaWAN or NB-IoT. An architecture that uses blockchain technology to provide secure and decentralized storage and processing of feature descriptor data.

The proposed ULS can be achieved using a combination of larger upstream processors and smaller co-processors that utilize lightweight feature descriptors to provide real-time processing of sensor data. This architecture allows for the division of labor between the two processors, with the larger processor handling heavy computation tasks and the smaller processor focusing on low-latency tasks such as real-time feature extraction and processing. There are many potential variations of this architecture, each with different trade-offs between upstream processing resources and downstream processing capability.

The proposed ULS can be achieved using a co-processor that takes the feature descriptors as inputs instead of raw sensor data or aerial imagery datasets. The preprocessing step for the raw sensor data and aerial imagery datasets is essential to convert the data into a format that can be easily processed by the co-processor. The co-processor can be designed as a lightweight architecture that leverages the output of the larger upstream processor to utilize the feature descriptor data, enabling existing systems to add the more precise localization capability without requiring a new dedicated processor architecture.

The proposed ULS is made up of several subsystems, each of which plays a crucial role in the overall function of the system. The subsystems are: Sensor subsystem: This subsystem is responsible for collecting data from various sensors such as cameras, lidar, GPS, etc. The raw sensor data is then transmitted to the upstream processor for preprocessing. Upstream processor subsystem: This subsystem is responsible for preprocessing the raw sensor data and transforming it into feature descriptor data. The feature descriptors are compact representations of the data that allow for efficient transmission and processing. The preprocessing step involves tasks such as image segmentation, object recognition, and feature extraction. Co-processor subsystem: This subsystem is responsible for real-time feature matching and processing using the lightweight feature descriptors. The co-processor utilizes a vision positioning system to triangulate a more precise position by using the vision position system. This enables localization of vehicles or devices with submeter precision. Aerial imagery dataset subsystem: This subsystem is responsible for storing and processing high-resolution aerial imagery datasets that are used as a reference for localization. The datasets consist of high-resolution images captured at 7-15 cm or 15-30 cm GSD. Database subsystem: This subsystem is responsible for storing the processed data and metadata, including the registered point clouds and bird's eye view images of the environment.

The communication topology between the subsystems is as follows: The 3D GMK sends raw sensor data to the upstream processor subsystem, which preprocesses the data and sends it to the co-processor subsystem as feature descriptor data. The co-processor subsystem uses the feature descriptors to localize the vehicle and sends the data to the database subsystem for storage. The aerial imagery dataset subsystem also sends data to the database subsystem, which is then used by the co-processor subsystem to match with the aerial imagery and improve the accuracy of localization.

Each of these subsystems has its own components, which can be further expanded upon. For example, the sensor subsystem may have components such as cameras, lidar, and GPS sensors. The upstream processor subsystem may have components such as image segmentation algorithms, object recognition algorithms, and feature extraction algorithms. The co-processor subsystem may have components such as a vision positioning system, a feature matching algorithm, and a triangulation algorithm.

The co-processor subsystem plays a crucial role in the proposed solution by providing real-time processing of the feature descriptor data. This subsystem is designed to be lightweight and efficient, allowing it to operate in real-time without being limited by the more resource-intensive processing requirements of the upstream processor subsystem.

The co-processor subsystem consists of several subcomponents, including: Vision positioning system: This component is responsible for triangulating a more precise position using the vision position system, which enables localization of vehicles or devices with submeter precision. Feature matching algorithm: This component is responsible for cross-matching image-based features with sensor data to determine the location of a vehicle or device. Triangulation algorithm: This component is responsible for determining the precise location of a vehicle or device based on the data from the vision positioning system and the feature matching algorithm. The co-processor subsystem interacts with the larger data pipeline by receiving the feature descriptor data from the upstream processor subsystem and processing it in real-time. The processed data is then transmitted back to the database subsystem for storage. This enables the co-processor subsystem to work in concert with the other subsystems, providing a more efficient and effective solution for localization. The co-processor subsystem is designed to be flexible and scalable, allowing it to be integrated with a wide range of existing systems. This allows existing systems to add the more precise localization capability without requiring a new dedicated processor architecture, but rather an architecture that utilizes the output of the larger upstream processor to leverage lightweight feature descriptor data.

The proposed ULS may also utilize a single host architecture for end-to-end processing of the data pipeline, enabling more precise localization of vehicles or devices. The single host architecture consists of several subcomponents, including: Aerial imagery datasets: High-resolution images captured at 7-15 cm or 15-30 cm GSD, which serve as a reference for localization. Vision positioning system: This component is responsible for triangulating a more precise position using the vision position system, which enables localization of vehicles or devices with submeter precision. Feature matching algorithm: This component is responsible for cross-matching image-based features with sensor data to determine the location of a vehicle or device. Triangulation algorithm: This component is responsible for determining the precise location of a vehicle or device based on the data from the vision positioning system and the feature matching algorithm. Lidar SLAM and lidar odometry: This component is responsible for registering a point cloud using lidar SLAM and lidar odometry. Bird's eye view image creation: This component is responsible for creating a bird's eye view image of the environment using the registered point cloud. Image matching algorithm: This component is responsible for matching the bird's eye view image with aerial imagery to localize the vehicle. Database subsystem: This component is responsible for storing the processed data.

The single host architecture processes the data from end to end, from the aerial imagery datasets and sensor data, to the triangulation algorithm, and finally to the database subsystem for storage. This end-to-end processing enables the system to provide a more precise and reliable way of determining the location of a vehicle or device.

The single host architecture utilizes hyperspectral imagery to help with image segmentation and classification of objects from the aerial perspective. This allows the ULS to provide more accurate results, even in situations where traditional localization solutions based on GPS/GNSS or HD Maps/Feature Maps may be prone to noise, incomplete coverage, and spoofing vulnerability.

The proposed ULS may utilize a cloud/device architecture for more precise localization of vehicles or devices. The cloud/device architecture consists of two main components: the cloud-based component and the device-based component.

The cloud-based component consists of several subcomponents, including: Aerial imagery datasets: High-resolution images captured at 7-15 cm or 15-30 cm GSD, which serve as a reference for localization. Feature matching algorithm: This component is responsible for cross-matching image-based features with sensor data to determine the location of a vehicle or device. Triangulation algorithm: This component is responsible for determining the precise location of a vehicle or device based on the data from the device-based component and the feature matching algorithm. Image matching algorithm: This component is responsible for matching the bird's eye view image with aerial imagery to localize the vehicle. Vision positioning system: This component is responsible for triangulating a more precise position using the vision position system, which enables localization of vehicles or devices with submeter precision. Database subsystem: This component is responsible for storing the processed data.

The device-based component consists of several subcomponents, including: GPS/GNSS Inertial system: This component is responsible for initializing the starting position of the localization search. Lidar SLAM and lidar odometry: This component is responsible for registering a point cloud using lidar SLAM and lidar odometry. Bird's eye view image creation: This component is responsible for creating a bird's eye view image of the environment using the registered point cloud.

The device-based component sends the data to the cloud-based component, which processes the data and determines the precise location of a vehicle or device. The cloud-based component utilizes hyperspectral imagery to help with image segmentation and classification of objects from the aerial perspective, enabling more accurate results even in challenging environments.

The ULS may determine the location of a DPV or device using aerial imagery datasets by obtaining a rough GPS location, using the rough GPS location to triangulate a more precise position by using the vision positioning system, cross-matching image-based features with sensor data to provide a more reliable way of determining the location of the DPV or device, utilizing hyperspectral imagery to assist in image segmentation and classification of objects from an aerial perspective, utilizing unsupervised image segmentation on the ground to match against clusters from the hyperspectral images, registering a point cloud using lidar SLAM and lidar odometry, creating a bird's eye view image of the environment using the registered point cloud, matching the bird's eye view image with aerial imagery to localize the DPV.

The ULS may determine the location of a DPV or device using aerial imagery datasets, comprising: a vision positioning system; a hyperspectral imagery processing subsystem; a lidar SLAM subsystem; a co-processor; a system on chip; a microcontroller; a communication protocol; a preprocessing step for raw sensor data and aerial imagery datasets; and a feature descriptor data generation subsystem.

The ULS may determine the location of a DPV or device using aerial imagery datasets, the method utilizing a co-processor to process feature descriptors as inputs instead of raw sensor data or aerial imagery datasets.

The ULS may locate my vehicle or device using aerial imagery datasets, the system comprising a co-processor to process feature descriptors as inputs instead of raw sensor data or aerial imagery datasets.

The ULS may locate my DPV or device using aerial imagery datasets, the system utilizing a co-processor to process feature descriptors as inputs instead of raw sensor data or aerial imagery datasets, the co-processor comprising a microcontroller.

The ULS may determine the location of a DPV or device using aerial imagery datasets, the method utilizing a co-processor to process feature descriptors as inputs instead of raw sensor data or aerial imagery datasets, the co-processor utilizing a microcontroller.

The ULS may locate the DPV or device using aerial imagery datasets, the system comprising a single host architecture with end to end processing of the data pipeline.

The ULS may locate the DPV or device using aerial imagery datasets, the method utilizing a single host architecture with end to end processing of the data pipeline.

The ULS may locate the DPV or device using aerial imagery datasets, the system comprising a cloud or device architecture.

The ULS may locate the DPV or device using aerial imagery datasets, the method utilizing a cloud or device architecture.

The ULS may locate the DPV or device using aerial imagery datasets, the system utilizing a cloud or device architecture, the architecture comprising a data pipeline with preprocessing, feature descriptor data generation, and localization subsystems.

The ULS may locate the DPV or device using aerial imagery datasets, the method utilizing a cloud or device architecture, the architecture utilizing a data pipeline with preprocessing, feature descriptor data generation, and localization subsystems.

The ULS may locate the DPV or device using aerial imagery datasets, the system utilizing low bandwidth protocols for communication between subsystems.

The ULS may locate the DPV or device using aerial imagery datasets and a vision positioning system.

The ULS may locate the DPV using aerial imagery datasets and a vision positioning system with sub meter precision, that is not limited by coverage with cross-matching capabilities between the aerial reference imagery dataset and the 3D GMK sensor data. The aerial reference imagery data may choose to utilize hyperspectral imagery or unsupervised image segmentation as additional layers of data in addition to the RGB color channels.

The ULS may stream the localization output to a LiDAR SLAM or Odometry pipeline which is utilized to register a point cloud. The registered point cloud may be converted into a bird's eye image of the environment and cross referenced with the aerial imagery to further refine the localization output of the ULS.

The ULS may utilize a co-processor that receives light weight feature descriptors as inputs instead of raw sensor data or aerial imagery datasets enabling a light weight feature descriptor to position the DPV. Depending on the compute budget of a light weight feature descriptors, certain microcontrollers may qualify to act as a co-processor within the ULS architecture.

The ULS may utilize a co-processing that receives raw sensor data from the 3D GMK as inputs or aerial imagery datasets to position the DPV. A system on chip with larger computing capabilities may accelerate processing on the raw sensor data or aerial imagery using specialized accelerators as defined in FIG. 11.

The ULS may utilize a pipeline to transform sensor data into feature descriptor data and the send this feature descriptor data to the co-processor over low bandwidth signal bus architectures. Some examples of a low bandwidth signal bus may include CANBus or Multi-Vehicle Bus or other similar protocols.

The ULS may utilize a localization pipeline to estimate the localization output of the DPV with greater precision and accuracy, processing raw sensor data or feature descriptor data directly on the Host architecture.

The ULS may utilize a localization pipeline to estimate the localization output of the DPV with greater precision and accuracy, processing raw sensor data or feature descriptor data directly on the Cloud architecture.

The ULS may locate the DPV using aerial imagery datasets, comprising: receiving a rough GPS location of the vehicle; using a vision positioning system to triangulate a more precise position by cross-matching image-based features with sensor data from the 3D GMK; and determining the location of the vehicle based on the triangulated position.

The ULS may locate the DPV using aerial imagery datasets, comprising: a vision positioning system for triangulating a more precise position of the vehicle based on cross-matching image-based features with sensor data; and a processor for determining the location of the vehicle based on the triangulated position.

The ULS may locate the DPV, further comprising a co-processor for receiving feature descriptors from the processor and utilizing lightweight processing capabilities to perform localization.

The ULS may locate the DPV, wherein the aerial imagery datasets consist of high-resolution images captured at 7-15 cm or 15-30 cm GSD.

The ULS may locate the DPV wherein the triangulated position is determined by utilizing a rough GPS location of the vehicle.

The ULS may locate the DPV wherein the cross-matching image-based features with sensor data is performed using unsupervised image segmentation on the ground.

The ULS may locate the DPV further comprising a lidar SLAM using lidar odometry to register a point cloud, and creating a bird's eye view image of the environment.

The ULS may locate the DPV further comprising a hyperspectral imagery to assist with image segmentation and classification of objects from the aerial perspective.

The ULS may locate the DPV wherein the aerial imagery datasets are used as a reference for localization and provide a more reliable way of determining the location of the DPV compared to GPS/GNSS or HD Maps/Feature Maps.

The ULS may locate the DPV using a co-processor, comprising: preprocessing raw sensor data and aerial imagery datasets; transforming the sensor data into feature descriptor data; and sending the feature descriptor data to the co-processor over low bandwidth protocols.

The ULS may locate the DPV utilizing a microcontroller as the co-processor and a system on chip as the larger upstream processor.

The ULS may locate the DPV using a co-processor, comprising: a preprocessor for preprocessing raw sensor data and aerial imagery datasets; a transformer for transforming the sensor data into feature descriptor data; a co-processor for receiving the feature descriptor data and utilizing lightweight processing capabilities to perform localization; and a communication mechanism for sending the feature descriptor data to the co-processor over low bandwidth protocols.

The ULS may utilize a microcontroller as the co-processor and a system on chip as the larger upstream processor.

The ULS may utilize a preprocessor and a transformer integrated into a single host architecture for end to end processing of the data pipeline.

The ULS may utilize a co-processor and larger upstream processor integrated into a cloud architecture for remote processing of the data pipeline.

The ULS may localize the DPV using a single host architecture, comprising: preprocessing raw sensor data and aerial imagery datasets; transforming the sensor data into feature descriptor data; and utilizing a single host architecture for end to end processing of the data pipeline to perform localization.

The ULS may localize the DPV using a single host architecture, comprising: a preprocessor for preprocessing raw sensor data and aerial imagery datasets; a transformer for transforming the sensor data into feature descriptor data; and a single host architecture for end to end processing of the data pipeline to perform localization.

The ULS may localize the DPV or device, comprising a cloud architecture that utilizes a combination of aerial imagery datasets and sensor data to triangulate a precise position.

The ULS may utilize a cloud architecture which processes aerial imagery datasets that consist of high-resolution images captured at sub-meter precision with 7-30 cm GSD.

The ULS may utilize a cloud architecture using a rough GPS location and triangulating a more precise position using a vision position system.

The ULS may utilize a cloud architecture using cross-matching image-based features with sensor data to provide a more reliable way of determining the location of a vehicle or device.

The ULS may localize the DPV or device, utilizing a combination of aerial imagery datasets and sensor data in a cloud architecture to triangulate a precise position.

The ULS may localize the DPV with a cloud architecture to aid in image segmentation and classification of objects from an aerial perspective.

The ULS may localize the DPV with the use of LiDAR SLAM and/or LiDAR Odometry in the cloud architecture to register a point cloud and create a bird's eye view image of the environment.

The ULS may match the registered point cloud with aerial imagery in the cloud architecture to localize the vehicle.

The ULS may utilize a co-processor in the cloud architecture to take feature descriptors as inputs, enabling existing systems to add precise localization capabilities without requiring a new dedicated processor architecture.

The ULS may arrive at a precise localization estimation using image-based triangulation and cross-matching of sensor data and aerial imagery datasets.

The ULS may arrive at a precise localization estimation using hyperspectral imagery for improved image segmentation and classification of objects from an aerial perspective.

The ULS may arrive at a precise localization estimation using LiDAR SLAM and/or LiDAR Odometry to register a point cloud and create a bird's eye view image of the environment.

The ULS may arrive at a precise localization estimation using an unsupervised image segmentation algorithm on the ground to match against clusters from hyperspectral images.

With raw sensor data and a precise ULS localization output, the registered point cloud is able to register shapes, features and classifications extracted from the registered point cloud data into a global coordinate system with a sub-meter accuracy. As the DPV is moving through the coordinate frame; the sensor data may be converted into a world model or 3D map representation with semantic context. This system is hereinafter referred to as Real Time Mapping System (RTMS).

The RTMS may utilize certain subcomponents in order to properly function and deliver a real time map representation of the scene. The subcomponents are not limited to the ones disclosed here, and other variations of subcomponents which may be easily deduced also fall within the scope of this invention. The map generation module processes registered point cloud data to extract features as points, lines, polygons or any other arbitrary geometric representation. The semantic module processes the feature geometry which is extracted from the raw sensor data to define the connectivity between the objects in the scene. The query engine module utilizes spatial reasoning from Large Language Models or Large Multimodal Models or any form of a neural network which is capable of processing multiple modalities of data alongside a user prompt to use its reasoning capabilities to measure, analyze, deduce or recommend actions. The hierarchy of how the information is transformed is showcased in FIG. 12.

The RTMS may be utilized to create a database of scenarios from the DPV fleet. Fleet learning is a machine learning framework that involves utilizing data from a fleet of vehicles to improve the accuracy and robustness of HD maps. In this framework, data from a fleet of DPVs is offloaded to the cloud for processing and used to create 3D scenarios that represent the real-world environment. This data can then be used to train machine learning models for a variety of applications, including object detection, segmentation, and behavior prediction.

The RTMS may be utilized to process real-world sensor data or procedurally generated synthetic data. Real-world data is collected from the DPV 3D GMK sensor data equipped with sensors such as cameras, lidar, and radar. This data provides a wealth of information about the environment, but is often limited in terms of quantity and diversity. On the other hand, procedurally generated synthetic data can be generated in large quantities and can represent a wide range of scenarios, including rare and challenging conditions.

The RTMS may balance data of both real-world and synthetic data, the framework of fleet learning typically involves using sensor playback to simulate the collection of real-world sensor data in a controlled environment. This allows for the creation of large, diverse datasets that can be used to train machine learning models. The use of both real-world and synthetic data helps to ensure that the models trained within this framework are robust and capable of handling a wide range of scenarios.

The RTMS may leverage real-time maps to run vision analytics, this involves using the information contained within HD maps to initially process and analyze sensor data on the edge. This can be particularly useful for reducing the amount of data that needs to be transmitted to the cloud, as well as for reducing the processing requirements on the cloud. By leveraging the information contained within the HD maps, edge devices can quickly identify and process the most relevant data, reducing the overall processing time and computational resources required.

The RTMS may expose the Query Module for receiving prompts via text, or voice to solicit certain analysis from the 3D Geospatial Map. The Spatial Reasoning capability of the Large Language Models or Large Multimodal Models or neural networks may describe the surrounding environment, including the shapes, connectivity, and relationships of objects and infrastructure within the environment. This information is crucial for enabling the planning modules of the system to formulate a policy on how to interact with the physical world.

The RTMS may provide Real-time maps with context around shapes, connectivity, and relationships by creating a high-definition representation of the environment, including information about the location, orientation, and properties of objects and infrastructure. This information can be used to inform insights about the current state of the environment, allowing 3rd party systems to make informed decisions about how to understand & interact with the world.

The RTMS may provide semantic layers in HD maps describing the relationships between objects and infrastructure in the environment, and can be observed through vehicle movements and state transitions in the infrastructure, such as a traffic signal changing color. These layers provide additional context to the environment, allowing the planning modules to make more informed decisions about how to interact with the world.

The RTMS may additionally integrate large language models to describe the context of the environment using natural language processing to capture the spatial context by extrapolating or inferring through spatial reasoning. This allows for more nuanced descriptions of the environment, including the relationships between objects and infrastructure, and the overall context of the situation. This information may be used by 3rd party systems to make more informed decisions about how to interact with the physical world.

The RTMS's map generation module plays a crucial role in providing the underlying geometry information needed for the semantic and query modules. The semantic context and the spatial reasoning outputs greatly benefit from the geometry information encapsulated in the map generation module. By combining vectorized feature data with semantic layers and natural language processing, the system is able to provide a comprehensive and accurate representation of the environment, allowing for safe and efficient interactions with the world.

The RTMS training infrastructure for the Query Modulel utilizes ground truth data which describes the semantic context of a scene using a combination of input frames and an output which consists of the geometry, relational data and example generated responses to different types of queries.

The RTMS training infrastructure depends on training data. The input to the training system includes a large dataset of text descriptions of scenes, along with annotations that indicate the relevant objects, infrastructure, and relationships in the scene. This data is used to train the large language model to generate descriptive text that accurately captures the spatial context of a scene.

The RTMS training infrastructure utilizes an MLOps pipeline to train and publish modules. The output of the training process is a large language model or large multimodal model that is capable of generating text descriptions, relational data, shapes of scenes that accurately capture the semantic context of the environment, including the location, orientation, and properties of objects and infrastructure, and the relationships between these components.

The RTMS Query Module can then be used in real time to provide an additional layer of information on top of the geometry and connectivity layers of the HD map. By using the Query Module to generate descriptive text of the scene, relationship data representing a topology or an analysis of the scene represented with text, images, vector data or other arbitrary data formats, the system is able to provide a more complete and nuanced representation of the environment, allowing for more informed decision-making.

The RTMS Query Module queries the large language model (LLM) to determine the relationship between objects in the environment by using a combination of the vehicle's localization information and the information stored in the HD map.

The ULS is critical to accurately place the DPV within the HD map, providing the necessary information to describe objects in relation to the DPV's position. This information can be used to generate queries to the Query Module that describe the relationship between objects in the environment.

The ULS, combined with the Semantic Module would use the DPV's position and orientation, as well as the relative distances and positioning information stored in the HD map, to accurately describe the relationship between the traffic signal and the lane. The Query Module would then use this information to generate a text description of the scene that accurately reflects the relationship between the objects, such as “The left-most traffic signal corresponds to the left-most lane at the intersection.”

The RTMS by utilizing the information from both the ULS and the prior HD map, the system is able to accurately understand the relationship between objects in the environment, allowing for safe and efficient decision-making. The ability to query the Query Module to obtain a generative response in the form of text, images or map data depicting the scene allows for a more intuitive and human-understandable representation of the environment.

The RTMS generates a scene context/geometry layer that provides a high-level understanding of the surrounding environment, including the location and relative placement of objects within the scene. This information may be used by 3rd party systems to build a more detailed understanding of the environment, including the identification and characterization of objects and their properties.

The RTMS facilitates the flow of information through APIs which are used to communicate between the two systems. The APIs may include request/response payloads that allow the 3rd party systems to query the Semantic Module or Query Modules for information about specific objects or regions within the scene. The payloads may include queries for the location, shape, and other properties of objects, as well as requests for more detailed information about specific regions or areas within the scene.

The RTMS may provide responses to these requests, the Semantic Module and Map Generation Module will provide the necessary information, including any relevant data and metadata, to the 3rd party system This information may be used by the 3rd party system to generate a more complete and accurate representation of the environment, including the properties and relationships between objects, and to support various tasks which rely on interacting with the environment in the physical or digital environment.

The RTMS utilizes an information topology that seamlessly connects the localization/scene context/geometry/generative layers with APIs that allow for request/response payloads to be exchanged.

The RTMS APIs serve as a communication interface between the different subcomponents, allowing any system to query the information generated by the other subcomponents and to provide semantic context for the scene.

For example, the RTMS may receive a request payload containing information about the location and orientation of the DPV, as well as data about the surrounding objects and their relationships to one another. The Query Module can then use this information to generate a response payload that provides a response using generative data of the scene, including the location and type of objects and any relevant information about their relationships. The generative data may consist of text, images, point cloud, vector data or relationship data.

The RTMS may define the endpoints of the APIs to be implemented using RESTful standards, and the payloads may be encoded in JSON or XML format. The payloads may contain information such as the location and orientation of the DPV, the type and location of objects in the scene, and any relevant metadata about the objects or the scene itself. The information flow between the different subcomponents will be constantly updated in real-time, allowing for a constantly evolving and highly accurate representation of the scene.

The RTMS may process time-series event data to identify patterns in the environment. This involves collecting data from multiple sources, such as the object list and state transitions in the environment. The event data is then analyzed to identify patterns that may be occurring. This can involve comparing the location of vehicles relative to stop bars or traffic signals and analyzing the timing of the vehicles' movements in relation to the state of the traffic signals.

The RTMS should encompass all the subcomponents of the HD mapping system and their interactions. This includes the sensor data processing, localization, scene context, geometry, relational data, and query interface which utilizes large language models or large multimodal models. The time series event data analysis and pattern recognition techniques used in the system should also be covered in the patent.

The RTMS should include the information topology and flow between components, including the APIs and endpoints used to exchange data between different subcomponents. The request/response payloads and the encoding of information in the HD map, including the localization information and the scene context and geometry data, should also be part of the patent coverage.

The RTMS should include the use of HD map in a wide range of applications. The use of HD maps in real-time, the ability to update roadsegment data with additional metadata, and the ability to configure the level of fidelity in the HD map, should also be covered in the patent. This scope provides a comprehensive coverage of the invention and its potential applications.

One major challenge is to synchronize the camera and LiDAR sensors in a DPV's 3D GMK. In FIG. 9 we describe a data pipeline which leverages a generative model that converts raw point cloud data from individual LiDAR frames into synthetic RGB data by training the generative model using other datasets which contain both camera and LiDAR frame data. This allows us to continue the 3D geospatial data collection process even if the camera or LiDAR sensors enter a non-functional or suboptimal state which prohibits that specific sensor modality to be compromised. In this case the generative pipeline defined in FIG. 9 allows the system to automatically recover by deriving synthetic data from other modalities. Hereby we refer to this system as the Synthetic Cross-Modality Data Generation Pipeline (SCMDGP).

The SCMDGP may utilize a sequence of processing modules to systematically convert data across modularities. One such example is deriving synthetic RGB data from the reflectivity information in the LiDAR.

Capturing ambient light information from a lidar sensor to create a 360 greyscale image. The lidar sensor emits laser beams and detects the reflections to measure the distance and create a 3D point cloud of the environment. The ambient light information is extracted from the point cloud data and used to create a greyscale image that represents the environment in a 2D format.

Integrating the greyscale image with a neural network that can colorize the image. The neural network is trained to colorize greyscale images by learning the relationship between the greyscale and the RGB values.

Training the neural network using co-mounted RGB images. The neural network is trained using a dataset of co-mounted RGB images, which are taken simultaneously with the lidar data. This allows the neural network to learn the relationship between the greyscale and RGB values in the context of the specific environment and lighting conditions.

The SCMDGP provides several advantages over the existing solutions. First, it allows for the conversion of lidar point clouds into RGB images, which are more suitable for visual perception tasks. Second, it uses the ambient light information from the lidar sensor to create a greyscale image, which does not need a sensor calibration process to closely align the image data with the point cloud data. Since both the original ambient light information and the grayscale image are captured from the same sensor frame of reference, we do not need to deal with time synchronization, extrinsic, intrinsic and the distortion calibration issues. Third, it uses a neural network that is trained using co-mounted RGB images, which allows the network to learn the relationship between the greyscale and RGB values in the context of the specific environment and lighting conditions.

The SCMDGP may be utilized in a non-real time environment for converting previously registered point cloud and trajectory data into 360 RGB images. The SCMDGP module can be used in various systems, such as ones that focus on self-driving cars, robotics, and mapping. The SCMDGP module provides a solution for converting previously registered point cloud data, which is not directly usable for visual perception tasks, into RGB images, which are more suitable for such tasks.

The SCMDGP data pipeline may follow these steps to perform the transformation from point cloud data into images.

Firstly, the pipeline performs the deregistration of point cloud and trajectory data. The point cloud data is transformed from its original cartesian coordinates to spherical coordinates using a deregistration process. The deregistration process involves converting the 3D cartesian coordinates to 2D spherical coordinates, which can be represented by a range, azimuth, and elevation. This allows for a more intuitive representation of the environment in a 2D format.

Secondly, the creation of a greyscale image from the deregistered data is possible as we go from cartesian space to the pixel space. The greyscale image is created by mapping the cartesian coordinates to the XY pixel coordinates in the image. The intensity value of each pixel is mapped back to the reflectivity or ambient light signal in the point cloud data.

Lastly, the integration of the greyscale image with a neural network that can colorize the image. The neural network is trained to colorize greyscale images by learning the relationship between the greyscale and the RGB values.

Training the neural network using co-mounted RGB images. The neural network is trained using a dataset of co-mounted RGB images, which are taken simultaneously with the point cloud data. This allows the neural network to learn the relationship between the greyscale and RGB values in the context of the specific environment and lighting conditions.

Translation of spherical coordinates to pixel coordinates. The spherical coordinates are translated to pixel coordinates, which allows for the creation of a 360 RGB image. This can be achieved by using a transformation matrix that maps the spherical coordinates to the corresponding pixel coordinates.

Point cloud and trajectory data: The point cloud and trajectory data are used as input for the conversion process.

Deregistration module: The deregistration module is responsible for transforming the point cloud data from its original cartesian coordinates to spherical coordinates.

Greyscale image creation module: The greyscale image creation module is responsible for creating a greyscale image from the deregistered data.

Colorization neural network: The neural network takes the greyscale image as input and generates a corresponding 360 RGB image as output.

Coordinate translation module: The coordinate translation module is responsible for translating the spherical coordinates to pixel coordinates.

1. A system for scalable geospatial data collection, comprising: a dual-purpose vehicle configured to operate as a transportation network vehicle and a geospatial mapping vehicle; a 3D geospatial mapping kit mounted on the dual-purpose vehicle, the 3D geospatial mapping kit comprising a multi-modal sensor suite for collecting geospatial data; and a ubiquitous localization solution (ULS) configured to determine a precise location of the dual-purpose vehicle using aerial imagery datasets and the collected geospatial data.

2. A method for scalable geospatial data collection, comprising: operating a dual-purpose vehicle as a transportation network vehicle and a geospatial mapping vehicle; collecting geospatial data using a 3D geospatial mapping kit mounted on the dual-purpose vehicle, the 3D geospatial mapping kit comprising a multi-modal sensor suite; determining a precise location of the dual-purpose vehicle using a ubiquitous localization solution (ULS) and aerial imagery datasets in conjunction with the collected geospatial data.

3. A system for creating a real-time map, comprising: a geospatial data collection subsystem for collecting geospatial data from a dual-purpose vehicle equipped with a 3D geospatial mapping kit; a localization subsystem for determining a precise location of the dual-purpose vehicle using a ubiquitous localization solution (ULS) and aerial imagery datasets; a map generation module for processing the collected geospatial data and the precise location to create a real-time map representation of the environment.

4. A method for creating a real-time map, comprising: collecting geospatial data from a dual-purpose vehicle equipped with a 3D geospatial mapping kit; determining a precise location of the dual-purpose vehicle using a ubiquitous localization solution (ULS) and aerial imagery datasets; processing the collected geospatial data and the precise location using a map generation module to create a real-time map representation of the environment.

5. The system of claim 1, wherein the multi-modal sensor suite comprises at least one of a camera, a LiDAR sensor, a GPS sensor, and a radar sensor.

6. The system of claim 1, wherein the ULS is configured to triangulate the precise location of the dual-purpose vehicle by cross-matching image-based features from the aerial imagery datasets with sensor data from the multi-modal sensor suite.

7. The system of claim 1, further comprising a data logging device for storing the collected geospatial data.

8. The system of claim 1, wherein the ULS utilizes unsupervised image segmentation on the ground to match against clusters from hyperspectral imagery in the aerial imagery datasets.

9. The system of claim 1, wherein the ULS is configured to register a point cloud using LiDAR SLAM and LiDAR odometry, and create a bird's eye view image of the environment for matching with the aerial imagery datasets.

10. The method of claim 2, wherein collecting geospatial data comprises acquiring data from at least one of a camera, a LiDAR sensor, a GPS sensor, and a radar sensor mounted on the dual-purpose vehicle.

11. The method of claim 2, wherein determining the precise location comprises triangulating the location by cross-matching image-based features from the aerial imagery datasets with sensor data from the multi-modal sensor suite.

12. The method of claim 2, further comprising storing the collected geospatial data in a data logging device.

13. The method of claim 2, wherein determining the precise location comprises utilizing unsupervised image segmentation on the ground to match against clusters from hyperspectral imagery in the aerial imagery datasets.

14. The method of claim 2, wherein determining the precise location comprises registering a point cloud using LiDAR SLAM and LiDAR odometry, and creating a bird's eye view image of the environment for matching with the aerial imagery datasets.

15. The system of claim 3, wherein the geospatial data collection subsystem comprises a multi-modal sensor suite including at least one of a camera, a LiDAR sensor, a GPS sensor, and a radar sensor.

16. The system of claim 3, wherein the localization subsystem utilizes a co-processor to process feature descriptors derived from the collected geospatial data and the aerial imagery datasets.

17. The system of claim 3, wherein the map generation module is configured to extract features, define connectivity between objects, and enable spatial reasoning and semantic contextualization based on the processed geospatial data and precise location.

18. The method of claim 4, wherein collecting geospatial data comprises acquiring data from a multi-modal sensor suite including at least one of a camera, a LiDAR sensor, a GPS sensor, and a radar sensor.

19. The method of claim 4, wherein determining the precise location comprises utilizing a co-processor to process feature descriptors derived from the collected geospatial data and the aerial imagery datasets.

20. The method of claim 4, wherein creating the real-time map representation comprises extracting features, defining connectivity between objects, and enabling spatial reasoning and semantic contextualization based on the processed geospatial data and precise location.

21. The system of claim 1, further comprising a synthetic cross-modality data generation pipeline (SCMDGP) configured to generate synthetic RGB data from LiDAR point cloud data.

22. The method of claim 2, further comprising generating synthetic RGB data from LiDAR point cloud data using a synthetic cross-modality data generation pipeline (SCMDGP).

23. The system of claim 21, wherein the SCMDGP is configured to capture ambient light information from the LiDAR point cloud data, create a grayscale image from the ambient light information, and colorize the grayscale image using a neural network trained on co-mounted RGB images.

24. The method of claim 22, wherein generating synthetic RGB data comprises capturing ambient light information from the LiDAR point cloud data, creating a grayscale image from the ambient light information, and colorizing the grayscale image using a neural network trained on co-mounted RGB images.
